(19) United States
(12) Patent Application Publication
(10) Pub. No.: US 2008/0304013 A1
(43) Pub. Date: Dec. 11, 2008

(54) Projection Type Stereoscopic Display Apparatus

(76) Inventor: Jong-Wook Seo, Seoul (KR)

Correspondence Address: THELEN LLP, P. O. BOX 640640, SAN JOSE, CA, 95164-0640, US

(21) Appl. No.: 12/095,314

(22) PCT Filed: Nov. 29, 2006
(86) PCT No.: PCT/KR06/05080

§ 371 Date: May 28, 2008

(30) Foreign Application Priority Data
Nov. 29, 2005 (KR) 10-2005-0114722

(51) Int. Cl. G02B 27/26; G03B 21/14

(52) U.S. Cl. 353/8

(57) ABSTRACT

Provided is a projection type stereoscopic display apparatus that can separately display far images and near images. The projection type stereoscopic display apparatus includes: a projector projecting a near image with first polarized light and a far image with second polarized light, which is different from the first polarized light of the near image, in a direction in which a viewer observes the near and far images; a front screen facing the projector, and allowing the near image with the first polarized light to be formed thereon and the far image with the second polarized light to be transmitted therethrough; and a rear screen spaced a predetermined distance apart from a rear surface of the front screen, and allowing the far image with the second polarized light transmitted through the front screen to be formed thereon, wherein the viewer positioned in front of the screen can simultaneously see the near image and the far image respectively formed on the front screen and the rear screen.

### CROSS REFERENCE TO RELATED APPLICATIONS OR PRIORITY CLAIM

This application is a national phase of International Application No. PCT/KR2006/005080, entitled “PROJECTION TYPE STEREOSCOPIC DISPLAY APPARATUS”, which was filed on Nov. 29, 2006, and which claims priority of Korean Patent Application No. 10-2005-0114722, filed Nov. 29, 2005.

### TECHNICAL FIELD

The present invention relates to a projection type stereoscopic display apparatus, and more particularly, to a projection type stereoscopic display apparatus that can separately display far images and near images.

### BACKGROUND ART

In general, projection type stereoscopic display apparatuses, which create stereoscopic images using binocular parallax, can be classified into display apparatuses using glasses and glassless display apparatuses according to whether a viewer wears glasses.

Glassless projection type stereoscopic display apparatuses separately provide a left eye image and a right eye image to a left eye and a right eye, respectively, using a lenticular lens or a diffraction grating, such that a viewer can see a stereoscopic image without wearing polarized glasses. However, since the stereoscopic image is provided using the lenticular lens or the diffraction grating, a viewing angle, that is, a maximum angle at which a display can be viewed with acceptable definition, is extremely limited.

Projection type stereoscopic display apparatuses using glasses separately provide a left eye image and a right eye image with different polarization directions formed on a single screen to a left eye and a right eye, respectively, using polarized glasses. However, it is inconvenient for viewers to wear the polarized glasses to see stereoscopic images.

### DETAILED DESCRIPTION OF THE INVENTION

### Technical Problem

The present invention provides a projection type stereoscopic display apparatus that can create a stereoscopic image by separating an original image into a far image and a near image, unlike a conventional projection type stereoscopic display apparatus that creates a stereoscopic image using binocular parallax.

### Technical Solution

According to an aspect of the present invention, there is provided a projection type stereoscopic display apparatus comprising: a projector projecting a near image with first polarized light and a far image with second polarized light, which is different from the first polarized light of the near image, in a direction in which a viewer observes the near and far images; a front screen facing the projector, and allowing the near image with the first polarized light to be formed thereon and the far image with the second polarized light to be transmitted therethrough; and a rear screen spaced a predetermined distance from the front screen, and allowing the far image with the second polarized light transmitted through the front screen to be formed thereon, wherein the viewer positioned in front of the screen can simultaneously see the near image and the far image respectively formed on the front screen and the rear screen.

According to another aspect of the present invention, there is provided a projection type stereoscopic display apparatus comprising: a projector projecting a near image with first polarized light and a far image with second polarized light, which is different from the first polarized light of the near image, in a direction opposite to a direction in which a viewer observes the near and far images; a rear screen facing the projector, and allowing the far image with the second polarized light to be formed thereon and the near image with the first polarized light to be transmitted therethrough; and a front screen spaced a predetermined distance from the rear screen in the direction in which the viewer observes the near and far images, and allowing the near image with the first polarized light to be formed thereon, wherein the viewer positioned in front of the front screen can simultaneously see the near image and the far image respectively formed on the front screen and the rear screen.

### ADVANTAGEOUS EFFECTS

Since the projection type stereoscopic display apparatus constructed as described above according to the present invention separates an original image into a far image and a near image and displays the far image and the near image on two separated screens, a viewer can comfortably see a stereoscopic image without wearing polarized glasses and without suffering eyestrain at a wider viewing angle, thereby obtaining the feeling of being beside real objects.

### DESCRIPTION OF THE DRAWINGS

In the drawings:

FIG. 1 is a perspective view of a projection type stereoscopic display apparatus according to an embodiment of the present invention.

FIG. 2 is a plan view illustrating an optical arrangement of the projection type stereoscopic display apparatus of FIG. 1.

FIGS. 3 and 4 are plan views illustrating modifications of a projector of the projection type stereoscopic display apparatus of FIG. 1, according to embodiments of the present invention.

FIG. 5 is a perspective view illustrating objects to be photographed by a camera.

FIG. 6 is the image of the objects of FIG. 5 as captured by a camera located at the axis origin.

FIGS. 7 and 8 respectively illustrate a near image and a far image separated from the original image of FIG. 6.

FIG. 9 is a plan view illustrating a projection type stereoscopic display apparatus according to another embodiment of the present invention.

### BEST MODE

The present invention will now be described more fully with reference to the accompanying drawings, in which exemplary embodiments of the invention are shown.

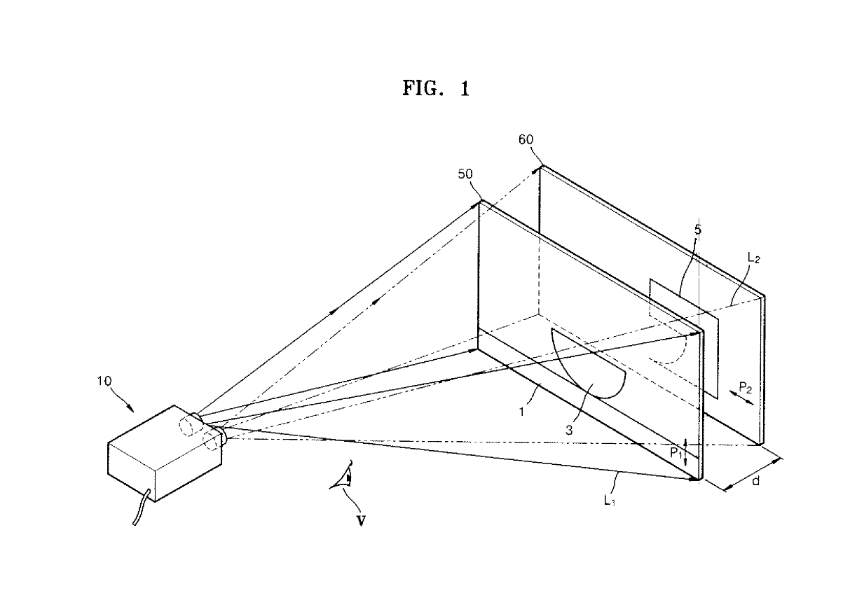

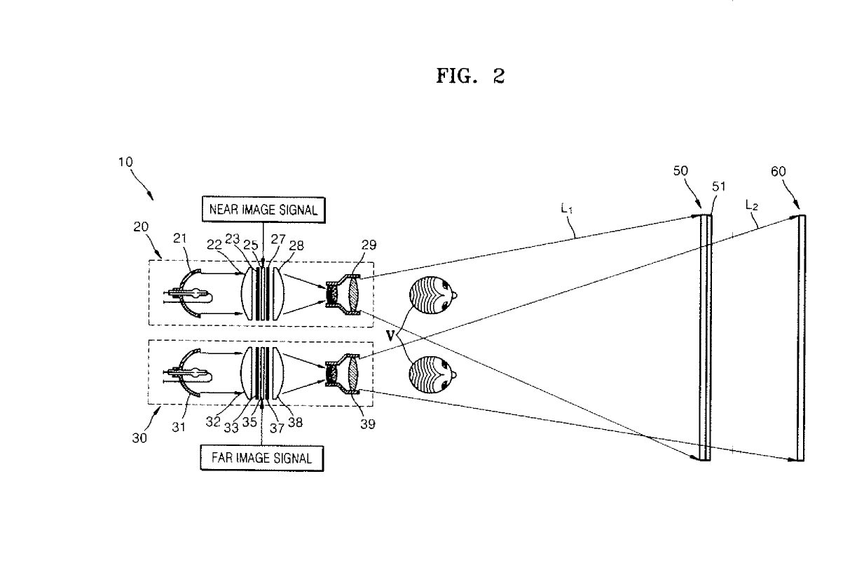

FIG. 1 is a perspective view of a projection type stereoscopic display apparatus according to an embodiment of the present invention. FIG. 2 is a plan view illustrating an optical arrangement of the projection type stereoscopic display apparatus of FIG. 1.

Referring to FIGS. 1 and 2, the projection type stereoscopic display apparatus, which is a front-projection type stereoscopic display apparatus, includes a projector 10, and a front screen 50 and a rear screen 60 which are spaced a predetermined distance from each other. Unlike a conventional projection type stereoscopic display apparatus using binocular parallax, the projection type stereoscopic display apparatus according to the present embodiment creates a stereoscopic image by separating an original image of objects into a near image and a far image, and separately projecting the near image and the far image to the front screen 50 and the rear screen 60, respectively.

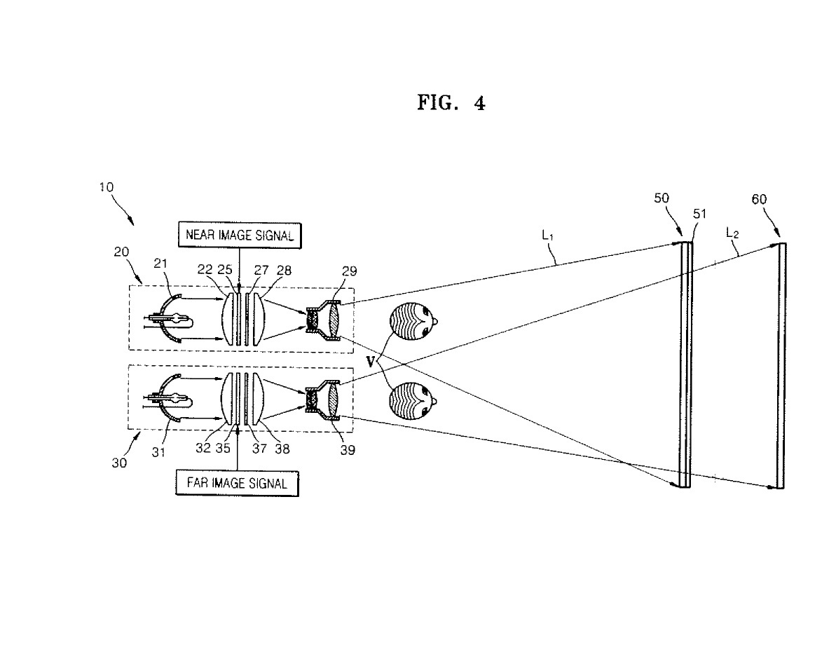

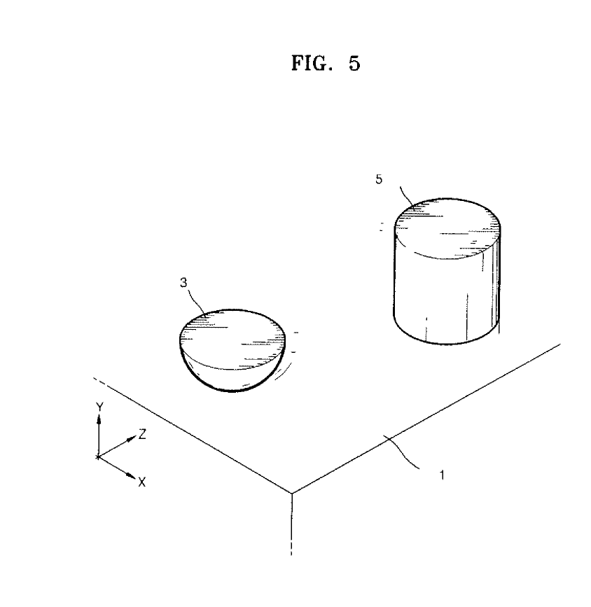

Before explaining the projection type stereoscopic display apparatus according to the present embodiment in detail, a method of acquiring a near image and a far image will be first explained with reference to FIGS. 5 and 6.

FIG. 5 is a perspective view illustrating objects to be photographed by a camera (not shown). Referring to FIG. 5, a hemispheric object 3 and a cylindrical object 5 are placed on a table 1 to be spaced a predetermined distance in a Z direction from each other. When the hemispheric object 3 and the cylindrical object 5 of FIG. 5 are photographed in the Z direction by the camera that is centered on the origin of coordinates, an image as illustrated in FIG. 6 is obtained. Since the image of FIG. 6 is not a stereoscopic image, when the image of FIG. 6 is projected onto a screen, the image does not provide a viewer with a sense of depth and distance regardless of the viewer's position.

However, a stereoscopic image providing a sense of depth and distance can be obtained by extracting a near image and a far image from an original image and projecting the near image and the far image to the front screen 50 and the rear screen 60 by means of the projector 10 as will be described later.

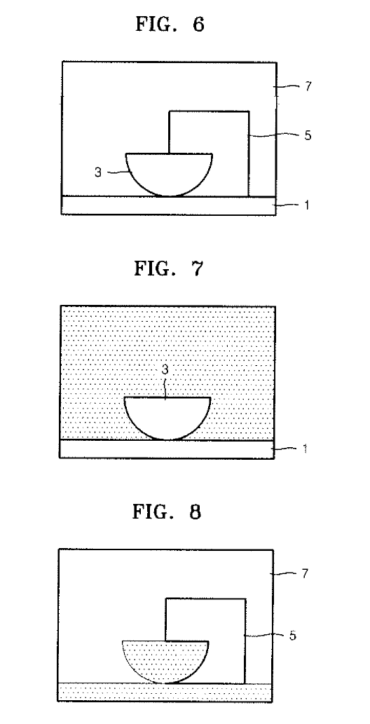

That is, the projection type stereoscopic display apparatus according to the present embodiment extracts image data of objects within a predetermined distance from the camera to form a near image. Here, an image other than the near image extracted from the original image appears as a dark background. For example, when the hemispheric object 3 and the cylindrical object 5 are located as illustrated in FIG. 5, image data of the table 1 and the hemispheric object 3 which are located within a predetermined distance from the camera is extracted as a near image data as illustrated in FIG. 7. Here, image data of the cylindrical object 5 and scenery 7 which are located beyond the predetermined distance from the camera is excluded from the near image data.

An image other than the near image extracted from the original image becomes a far image. In this case, the near image other than the far image appears as a dark foreground. For example, when the hemispheric object 3 and the cylindrical object 5 are located as illustrated in FIG. 5, image data of the cylindrical object 5 and the scenery 7 except the table 1 and the hemispheric object 3 is extracted as a far image data as illustrated in FIG. 8. Here, image data of the entire cylindrical object 5 is not included in the far image data, and only image data of a part of the cylindrical object 5 not covered by the hemispheric object 3 is included in the far image data.

Concerning the above-described method of extracting a far image data and a near image data from an original image taken using a camera, a far image and a near image may be extracted by obtaining object distance information in image data using a separate camera system and processing the distance information using digital image processing techniques. Alternatively, in the case of image data produced by computer graphics instead of direct photographing of objects, information on a near image data and information on a far image data may be produced independently.

The optical arrangement and operation of the elements of the projection type stereoscopic display apparatus illustrated in FIGS. 1 and 2 according to the present embodiment, which creates a stereoscopic image using a near image data and a far image data obtained as described above, will now be explained in detail.

Referring to FIGS. 1 and 2, the projector 10 is disposed in front of the front screen 50 and projects a near image L₁ with first polarized light P₁ and a far image L₂ with second polarized light P₂, which is different from the first polarized light P₁ of the near image L₁, in a direction in which a viewer V sees the near and far images L₁ and L₂. Accordingly, the viewer V positioned in front of the front screen 50 can simultaneously see the near image L₁ formed on the front screen 50 and the far image L₂ formed on the rear screen 60, thereby viewing a stereoscopic image.

To this end, the projector 10 includes a first projector 20 providing the near image L₁ and a second projector 30 providing the far image L₂ as illustrated in FIG. 2.

The first projector 20 includes a first light source 21 emitting light, a first image forming unit 25 selectively transmitting the light emitted by the first light source 21 and forming a near image L₁ corresponding to a near image data input thereto, a first polarization selecting unit 27 polarizing the light of the near image L₁ formed by the first image forming unit 25 so that the near image L₁ has first polarized light P₁, and a first projection lens unit 29 projecting the near image L₁ to the front screen 50 such that the near image L₁ is formed on the front screen 50.

The second projector 30 includes a second light source 31 emitting light, a second image forming unit 35 selectively transmitting the light emitted by the second light source 31 and forming a far image L₂ corresponding to a far image data input thereto, a second polarization selecting unit 37 polarizing the light of the far image L₂ formed by the second image forming unit 35 so that the far image L₂ has second polarized light P₂, and a second projection lens unit 39 projecting the far image L₂ to the rear screen 60 such that the far image L₂ is formed on the rear screen 60.

Here, the first and second light sources 21 and 31, which emit light to the first and second image forming units 25 and 35, respectively, may be illumination lamps, or electroluminescent devices such as light emitting diodes (LEDs) or semiconductor laser sources. When the first and second image forming units 25 and 35 preserve the polarization state of light input thereon, light may be emitted from one light source instead of the first and second light sources 21 and 31, and may be separated into first polarized light P₁ and second polarized light P₂ by means of a polarization beam splitter instead of the first and second polarization selecting units 27 and 37.

Each of the first and second image forming units 25 and 35 may be a transmissive liquid crystal display (LCD) that forms an image by selectively transmitting light. In this case, first and second polarizers 23 and 33 may be disposed between the first light source 21 and the first image forming unit 25 and between the second light source 31 and the second image forming unit 35 to separately transmit polarized light to the first and second image forming units 25 and 35, respectively. Alternatively, the polarization beam splitter may be employed to separate light emitted by one light source into first polarized light P₁ and second polarized light P₂ and respectively send the first polarized light P₁ and the second polarized light P₂ to the first and second image forming units 25 and 35. In this case, the first and second polarizers 23 and 33 may be unnecessary. Lenses 22 and 28, and 32 and 38 may be disposed in an optical path to focus incident light.

The first and second image forming units 25 and 35 are not limited to transmissive LCDs, and although not shown, may be reflective LCDs or digital micro-mirror devices (DMDs).

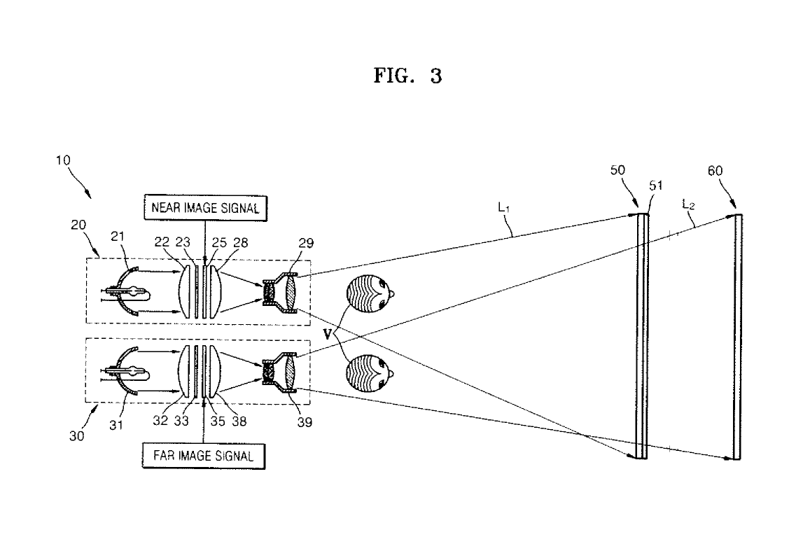

The first and second polarizers 23 and 33 and the first and second polarization selecting units 27 and 37 may be unnecessary according to the first and second image forming units 25 and 35. For example, when the first and second image forming units 25 and 35 are LCDs, since the LCDs include polarizers and analyzers therein, the first and second image forming units 25 and 35 can produce an image with specific polarized light without the first and second polarizers 23 and 33 and the first and second polarization selecting units 27 and 37. However, when the first and second image forming units 25 and 35 are DMDs which do not have polarization selecting capability, the first and second polarizers 23 and 33 and the first and second polarization selecting units 27 and 38 may be required selectively. The first and second polarizers 23 and 33 and the first and second polarization selecting units 27 and 37 are identical in function to each other in that both are for transmitting specific polarized light. Hence, the projection type stereoscopic display apparatus according to the present embodiment may include the first and second polarizers 23 and 33, the first and second polarization selecting units 27 and 37, or both the first and second polarizers 23 and 33 and the first and second polarization selecting units 27 and 37 according to the first and second image forming units 25 and 35. In FIG. 2, the first polarizer 23 and the first polarization selecting unit 27 are disposed on both sides of the first image forming unit 25, and the second polarizer 33 and the second polarization selecting unit 37 are disposed on both sides of the second image forming unit 35. FIGS. 3 and 4 are plan views illustrating modifications of the projector 10 of the projection type stereoscopic display apparatus of FIG. 1, according to embodiments of the present invention. In FIG. 3, the first and second polarizers 23 and 33 are respectively disposed on light incident sides of the first and second image forming units 25 and 35. In FIG. 4, the first and second polarization selecting units 27 and 37 are respectively disposed on light exit sides of the first and second image forming units 25 and 35.

Referring to FIG. 1, the front screen 50 and the rear screen 60 are spaced apart from each other by a predetermined distance “d”, for example, approximately 10 cm, so that the viewer V can gain sense of depth and distance. The near image L₁ is formed on the front screen 50 and the far image L₂ is formed on the rear screen 60.

In detail, referring to FIG. 2, the front screen 50 includes a polarizer film 51 that is disposed between the projector 10 and the rear screen 60 and diffuses and reflects the near image L₁ and transmits the far image L₂. Accordingly, the near image L₁ with the first polarized light P₁ is formed on the front screen 50 without being transmitted through the polarizer film 51. The far image L₂ with the second polarized light P₂ is transmitted through the polarizer film 51 to the rear screen 60 and is finally formed on the rear screen 60. The far image L₂ with the second polarized light P₂ formed on the rear screen 60 is transmitted through the front screen 50 again to reach the viewer V. The rear screen 60 may be formed of a material that can preserve the polarization state of incident light. The polarizer film 51 is formed of a well-known material, and thus, a detailed explanation thereof will not be given.

The distance “d” between the front screen 50 and the rear screen 60 is not limited to 10 cm, and may vary according to the sizes of the front and rear screens 50 and 60 and a reference viewing position.

In the projection type stereoscopic display apparatus constructed as described above according to the present embodiment, the near image L₁ with the first polarized light P₁ projected by the first projector 20 is formed on the front screen 50, and the far image L₂ with the second polarized light P₂ is transmitted through the front screen 50 and is formed on the rear screen 60. For example, when the near image L₁ and the far image L₂ are formed as illustrated in FIGS. 7 and 8, the near image of the table 1 and the hemispheric object 3 is formed on the front screen 50, and the far image of the cylindrical object 5 and the scenery 7 is formed on the rear screen 60.

Accordingly, the viewer V positioned between the projector 10 and the front screen 50 simultaneously sees the near image L₁ with the first polarized light P₁ formed on the front screen 50 and the far image L₂ with the second polarized light P₂ transmitted through the first polarizer film 51 and formed on the rear screen 60. The viewer V gains depth and distance perception by physiologically focusing both eyes to the real images formed on the front and rear screens 50 and 60.

There can be an overlapping region between the near image L₁ with the first polarized light P₁ and the far image L₂ with the second polarized light P₂. An overlapping region can represent an intermediate distance image locating between the near image L₁ and the far image L₂ by appropriately setting the brightness of a near image portion and a far image portion of the overlapping region, thereby producing a more realistic stereoscopic image.

Therefore, according to the present embodiment, the near image L₁ and the far image L₂ may have completely different image patterns, or may have image patterns such that the near image L₁ and the far image L₂ may partially or entirely overlap each other and the brightness of the overlapping region is determined by a relative distance from the viewer V.

### MODE OF THE INVENTION

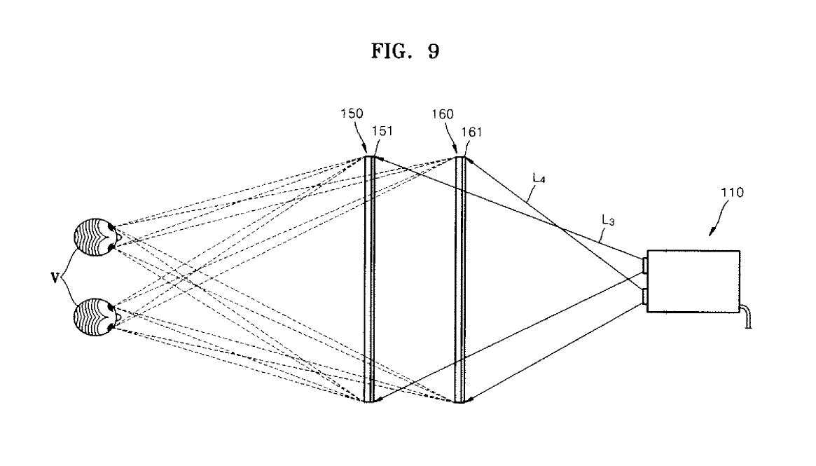

FIG. 9 is a plan view of a projection type stereoscopic display apparatus, which is a rear-projection type stereoscopic display apparatus, according to another embodiment of the present invention. Referring to FIG. 9, the projection type stereoscopic display apparatus includes a projector 110, and a front screen 150 and a rear screen 160 which are spaced apart from each other. The projection type stereoscopic display apparatus of FIG. 9 is identical to the projection type stereoscopic display apparatus of FIG. 1 in that an image is separated into a near image and a far image and the near image and the far image are separately projected to the front screen 150 and the rear screen 160, respectively, to create a stereoscopic image. However, the structures of the front screen 150 and the rear screen 160 of the projection type stereoscopic display apparatus of FIG. 9 are different from those of the projection type stereoscopic display apparatus of FIG. 1.

The projector 110 projects a near image L₃ with first polarized light P₃ and a far image L₄ with second polarized light P₄, which is different from the first polarized light P₃ of the near image L₃, in a direction opposite to a direction in which a viewer V observes the near and far images L₃ and L₄. The projector 110 has substantially the same construction and function as the projector 10 of FIG. 2, and thus a detailed explanation thereof will not be given.

The rear screen 160 faces the projector 110, and allows the far image L₄ to be formed thereon and the near image L₃ to be transmitted therethrough. To this end, the rear screen 160 includes a first polarizer film 161 that diffuses the far image L₄ with the second polarized light P₄ and transmits the near image L₃ with the first polarized light P₃. Accordingly, the first polarized light P₃ projected by the projector 110 is transmitted through the rear screen 160 to the front screen 150, whereas the second polarized light P₄ projected by the projector 110 forms a far image on the rear screen 160 instead of being transmitted through the rear screen 160.

The front screen 150 is closer to the viewer V than the rear screen 160 is, and allows the near image L₃ with the first polarized light P₃ transmitted through the rear screen 160 to be formed thereon. In order for the viewer V to see the far image L₄ with the second polarized light P₄ formed on the rear screen 160, the front screen 150 includes a second polarizer film 151 that transmits the second polarized light P₄ and diffuses the first polarized light P₃ transmitted through the rear screen 160.

Since the projection type stereoscopic display apparatus illustrated in FIG. 9 is constructed as described above according to the current embodiment of the present invention, the viewer V positioned in front of the front screen 150 can simultaneously see the near image L₃ and the far image L₄ respectively formed on the front screen 150 and the rear screen 160, thereby viewing a stereoscopic image with depth perception.

Also, as described above, there is an overlapping region between the near image L₃ with the first polarized light P₃ and the far image L₄ with the second polarized light P₄, and the overlapping region can represent an intermediate distance image locating between the near image L₃ and the far image L₄ by appropriately setting the brightness of a near image portion and a far image portion of the overlapping region, thereby producing a more realistic stereoscopic image.

Therefore, according to the present embodiment, the near image L₃ and the far image L₄ may have completely different image patterns, or may have image patterns such that the near image L₃ and the far image L₄ partially or entirely overlap each other and the brightness of the overlapping region is determined by a relative distance from the viewer V.

### INDUSTRIAL APPLICABILITY

The present invention is suitable for a display apparatus, and more particularly, to a stereoscopic display apparatus.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A projection type stereoscopic display apparatus comprising:
a projector projecting a near image with first polarized light and a far image with second polarized light, which is different from the first polarized light of the near image, in a direction in which a viewer observes the near and far images;
a front screen facing the projector, and allowing the near image with the first polarized light to be formed thereon and the far image with the second polarized light to be transmitted therethrough; and
a rear screen spaced a predetermined distance apart from the front screen, and allowing the far image with the second polarized light transmitted through the front screen to be formed thereon,
wherein the viewer positioned in front of the screen can simultaneously see the near image and the far image respectively formed on the front screen and the rear screen.

2. The projection type stereoscopic display apparatus of claim 1, wherein the front screen comprises a polarizer film that allows the near image with the first polarized light to be formed thereon and the far image with the second polarized light to be transmitted therethrough.

3. A projection type stereoscopic display apparatus comprising:
a projector projecting a near image with first polarized light and a far image with second polarized light, which is different from the first polarized light of the near image, in a direction opposite to a direction in which a viewer observes the near and far images;
a rear screen facing the projector, and allowing the far image with the second polarized light to be formed thereon and the near image with the first polarized light to be transmitted therethrough; and
a front screen spaced a predetermined distance apart from the rear screen in the direction in which the viewer observes the near and far images, and allowing the near image with the first polarized light to be formed thereon,
wherein the viewer positioned in front of the front screen can simultaneously see the near image and the far image respectively formed on the front screen and the rear screen.

4. The projection type stereoscopic display apparatus of claim 3, wherein the rear screen comprises a first polarizer film that allows the far image with the second polarized light to be formed thereon and the near image with the first polarized light to be transmitted therethrough, and the front screen comprises a second polarizer film that allows the far image with the second polarized light to be transmitted therethrough and the near image with the first polarized light transmitted through the rear screen to be formed thereon.

5. The projection type stereoscopic display apparatus of claim 1, wherein the projector comprises:
a first projector comprising a first light source emitting light, a first image forming unit receiving the light emitted by the first light source and forming a near image, a first polarization selecting unit polarizing the light of the near image so that the near image has first polarized light, and a first projection lens unit projecting the near image to the front screen such that the near image is formed on the front screen; and
a second projector comprising a second light source emitting light, a second image forming unit receiving the light emitted by the second light source and forming a far image, a second polarization selecting unit polarizing the light of the far image so that the far image has second polarized light, and a second projection lens unit projecting the far image to the rear screen such that the far image is formed on the rear screen.

6. The projection type stereoscopic display apparatus of claim 1, wherein the projector comprises:
a first projector comprising a first light source emitting light, a first image forming unit receiving the light emitted by the first light source and forming a near image, a first polarization selecting unit disposed between the first light source and the first image forming unit and selectively transmitting first polarized light among the light emitted by the first light source, and a first projection lens unit projecting the near image to the front screen such that the near image is formed on the front screen; and
a second projector comprising a second light source emitting light, a second image forming unit receiving the light emitted by the second light source and forming a far image, a second polarization selecting unit disposed between the second light source and the second image forming unit and selectively transmitting second polarized light among the light emitted by the second light source, and a second projection lens unit projecting the far image to the rear screen such that the far image is formed on the rear screen.

7. The projection type stereoscopic display apparatus of claim 1, wherein each of the first image forming unit and the second image forming unit is a liquid crystal display (LCD).

8. The projection type stereoscopic display apparatus of claim 4, wherein the projector comprises:
a first projector comprising a first light source emitting light, a first image forming unit receiving the light emitted by the first light source and forming a near image, a first polarization selecting unit polarizing the light of the near image so that the near image has first polarized light, and a first projection lens unit projecting the near image to the front screen such that the near image is formed on the front screen; and
a second projector comprising a second light source emitting light, a second image forming unit receiving the light emitted by the second light source and forming a far image, a second polarization selecting unit polarizing the light of the far image so that the far image has second polarized light, and a second projection lens unit projecting the far image to the rear screen such that the far image is formed on the rear screen.

9. The projection type stereoscopic display apparatus of claim 4, wherein the projector comprises:
a first projector comprising a first light source emitting light, a first image forming unit receiving the light emitted by the first light source and forming a near image, a first polarization selecting unit disposed between the first light source and the first image forming unit and selectively transmitting first polarized light among the light emitted by the first light source, and a first projection lens unit projecting the near image to the front screen such that the near image is formed on the front screen; and
a second projector comprising a second light source emitting light, a second image forming unit receiving the light emitted by the second light source and forming a far image, a second polarization selecting unit disposed between the second light source and the second image forming unit and selectively transmitting second polarized light among the light emitted by the second light source, and a second projection lens unit projecting the far image to the rear screen such that the far image is formed on the rear screen.

10. The projection type stereoscopic display apparatus of claim 4, wherein each of the first image forming unit and the second image forming unit is a liquid crystal display (LCD).
